(19) United States
(12) Patent Application Publication
(10) Pub. No.: US 2008/0126589 A1
(43) Pub. Date: May 29, 2008

(54) Systems and Methods for Selectively Connecting a Data Port to One of Multiple Peripheral Device Ports

(76) Inventors: Syed Mohammad Ali Husain, Lahore (PK); Hasan A. Rizvi, Lahore (PK); Syed Mohammad Amir Husain, Lahore (PK); Ashraf Wali, Lahore (PK)

Correspondence Address: LAW OFFICES OF MARK L. BERRIER, 3811 BEE CAVES ROAD, SUITE 204, AUSTIN, TX, 78746, US

(21) Appl. No.: 11/460,323

(22) Filed: Jul. 27, 2006

(51) Int. Cl. G06F 3/00

(52) U.S. Cl. 710/14

(57) ABSTRACT

Systems and methods for selectively coupling one of a group of peripherals to a computer. In one embodiment, a USB switch is coupled between a computer and multiple USB peripheral devices. The switch selectively connects the computer to either a single one of the peripherals, or none of the peripherals. The switch employs a microcontroller which receives control signals from the computer and controls a switching mechanism such as a set of multiplexers or relays to connect data lines from the computer to one of the peripheral ports of the switch, while disconnecting the remainder of the peripheral ports. The switch may also disconnect all of the peripheral ports. The switch may also incorporate a display which is controlled by the switch's microcontroller. One or more power sources may be included to provide power to each of the peripheral ports.

### BACKGROUND

1. Field of the Invention

The invention relates generally to electronic devices, and more particularly to systems and methods for enabling a control device such as a personal computer to be selectively connected to a group of peripheral devices, such that the control device can selectively communicate with a single one of the group of peripheral devices.

2. Related Art

The USB (universal serial bus) interface has become very common in today's computer systems. This interface is provided in personal computers to enable the connection of various peripheral devices to the computers. The types of peripheral devices that may be connected to the computer include a wide variety of devices, including input/output devices (e.g., keyboard, mouse, etc.,) office equipment (e.g., printers, scanners, external hard drives, etc.,) portable devices (e.g., personal digital assistants or PDAs, MP3 players, etc.,) and many others. These devices can communicate with the computer via the USB interface, as well as receiving power to operate the devices or recharge their batteries.

Typically, a personal computer may have several USB ports through which USB devices can be connected to the computer. Using these ports, multiple USB devices can be connected to the computer at the same time. For example, a personal computer may have an extra hard drive, a printer, a PDA and an MP3 player connected to it. If it is desired to connect more USB devices to the computer, a USB hub can be plugged into one of the computer's USB ports. A four-port hub would therefore provide three additional USB ports (the four ports of the hub, minus the one port of the computer to which the hub is connected.) As more devices are connected to the personal computer, however, the possibility of conflicts between the devices increases. These conflicts may prevent the devices from communicating properly with the computer.

While a typical user of a PC computer may have only several devices connected to the computer at one time, computers which are used for commercial applications may need to communicate with many more devices. For example, a device manufacturer may use a computer to load the devices with desired software, or with information such as maps, digital music, or the like. Because of the large number of devices, there may be a much higher likelihood of conflicts between the devices using conventional USB hubs. Additionally, although the USB standards theoretically provide for the connection of just over 100 devices, this may be insufficient to meet the needs of the user. For instance, a device manufacturer may wish to connect several hundred USB devices to the computer at the same time in order to program them. Still further, even if it is desired to connect a number of devices that is within the limits of the USB standards, the standards allow for each device to draw an amount of current (e.g., for operating or recharging the device,) and a computer typically cannot support the aggregate current that would be required if a large number of devices each drew the maximum allowed current.

It would therefore be desirable to provide systems and methods for connecting large numbers of USB devices to a computer, while avoiding conflicts that would impair communications with the devices, allowing connection of numbers of devices exceeding that allowed by the USB standards, and allowing each of these devices to draw the maximum allowable current without adversely affecting the computer or the other devices.

### SUMMARY OF THE INVENTION

This disclosure is directed to systems and methods that solve one or more of the problems discussed above and that enable a device such as a personal computer to be selectively connected to a group of peripheral devices, such that the control device can selectively communicate with a single one of the group of peripheral devices. In one particular embodiment, a USB switch is coupled between a computer and multiple USB devices. The USB switch selectively connects the computer to a single one of the USB devices, rather than making all of the USB devices visible to the computer at the same time. The USB switch employs a microcontroller which receives control signals from the computer and controls a set of multiplexers to connect data lines from the computer to one of the USB device ports of the switch, while disconnecting the remainder of the USB device ports. The USB switch may also disconnect all of the USB device ports. In this embodiment, the USB switch also incorporates a display which is controlled by the USB switch's microcontroller. This embodiment also includes one or more power sources which provide power to each of the USB device ports.

One embodiment comprises a system including a data port, a plurality of peripheral device ports and a switch. The switch is configured to selectively connect the data port to no more than one of the peripheral device ports. The switch may, for example, be used to connect a USB port of a computer to selected ones of a group of USB peripheral devices. The switch may be controlled by a processor which is contained in the switch. The processor may communicate with the computer through a control port to receive information regarding which of the peripheral device ports is to be connected to the data port. The switch may include a display (e.g., an LCD display) which can be controlled by the processor to display information relating to the status of the switch. The switch may include a power supply to provide power to the peripheral device ports.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the interconnection of a computer with several USB peripheral devices in accordance with the prior art.

FIG. 2 is a diagram illustrating a system for connecting a computer to one of a group of USB devices in accordance with one embodiment.

FIG. 3 is a functional block diagram illustrating the structure of a USB switch in accordance with one embodiment.

FIGS. 4A and 4B are diagrams illustrating alternative embodiments for providing power from multiple power supplies to USB peripheral ports in a USB switch.

FIG. 5 is a flow diagram illustrating the operation of the microcontroller of a USB switch in accordance with one embodiment.

FIG. 6 is a diagram illustrating the use of multiple switches to increase the number of USB peripherals connected to the computer in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for selectively coupling one of a group of USB peripherals to a computer. In one embodiment, a USB switch may either connect a single one of the USB peripherals to the computer, or disconnect all of the USB peripherals from the computer. The switch may include a display in order to provide a visual indication of the status of the switch, such as identifying a USB peripheral that is currently connected to the computer. The switch may also include one or more power supplies (internal or external) to provide power to the USB peripherals.

In one exemplary embodiment, a USB switch incorporates a data interface and a control interface which are configured to be connected to a computer. The USB switch also includes multiple USB ports which are configured to be connected to USB peripheral devices. A switching mechanism which includes several multiplexers is coupled between the data interface to the computer and the USB ports for the peripheral devices. The USB switch employs a microprocessor to control the multiplexers and thereby selectively connect the computer data interface to a single one of the USB peripheral ports. The microprocessor may alternatively control the multiplexers to disconnect all of the USB peripheral ports from the computer data interface. The microprocessor is coupled to the computer via a control interface which is separate from the data interface.

In this embodiment, the switch includes an LCD display which is coupled to the microprocessor. The microprocessor may control the display to provide any relevant information about the switch status, such as which (if any) of the peripheral ports is connected to the computer data interface, whether any errors have occurred in the operation of the USB switch, etc. The USB switch also includes power ports through which extra power supplies can be connected to the switch. The power ports are connected to the USB peripheral ports, so that power from the external power supplies can be provided to peripheral devices that are connected to each of the USB ports, regardless of whether or not be ports are connected to the computer data interface.

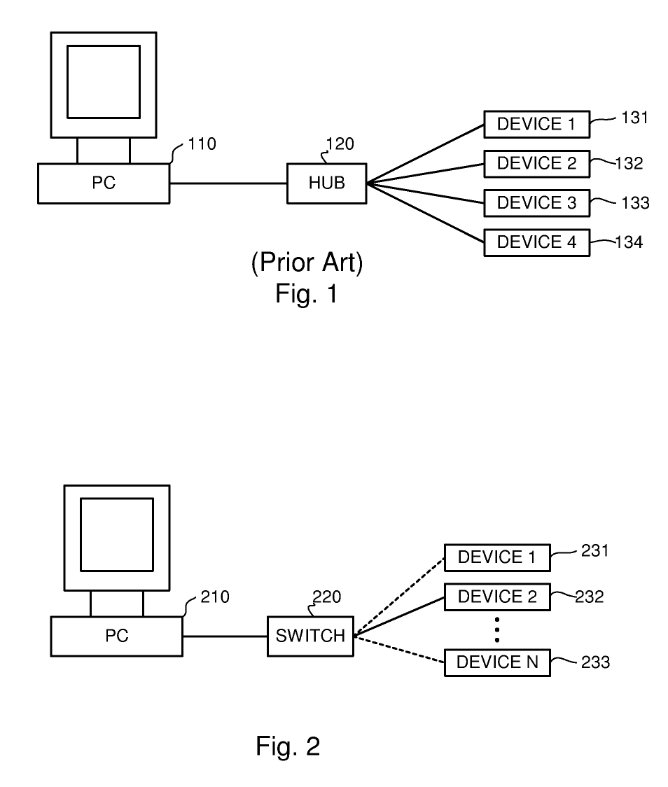

Before describing the exemplary embodiments of the present invention in detail, it will be useful to describe a system using a conventional USB hub. Referring to FIG. 1, a diagram illustrating the interconnection of a computer with several USB peripheral devices in accordance with the prior art is shown. In this system, computer 110 has a USB hub 120 connected to one of the USB ports of the computer. Four USB devices (131-134) are connected to hub 120.

In accordance with the USB standards, each of devices 131-134 is visible to computer 110. (It should be noted that the same would be true if devices 131-134 were each connected directly to corresponding USB ports of computer 110. USB hub 120 does not perform any switching between the devices.

Referring now to FIG. 2, a diagram illustrating a system for connecting a computer to one of a group of USB devices in accordance with one embodiment is shown. Computer 210 and peripheral devices 231-233 may be identical to the corresponding components of FIG. 1. The system of FIG. 2, however, uses a switch 220, rather than a conventional USB hub 120 to connect the peripheral devices to the computer. Switch 220 is configured to selectively connect one of devices 231-233 to computer 210. In FIG. 2, the solid line between switch 220 and device 232 indicates that this device is currently connected through the switch to computer 210 so that data may be communicated between computer and the device. The dotted lines between switch 220 and devices 231 and 233 indicate that, while these devices are physically connected to the switch, they are decoupled from computer 210, so that no data is communicated between the computer and either of these devices.

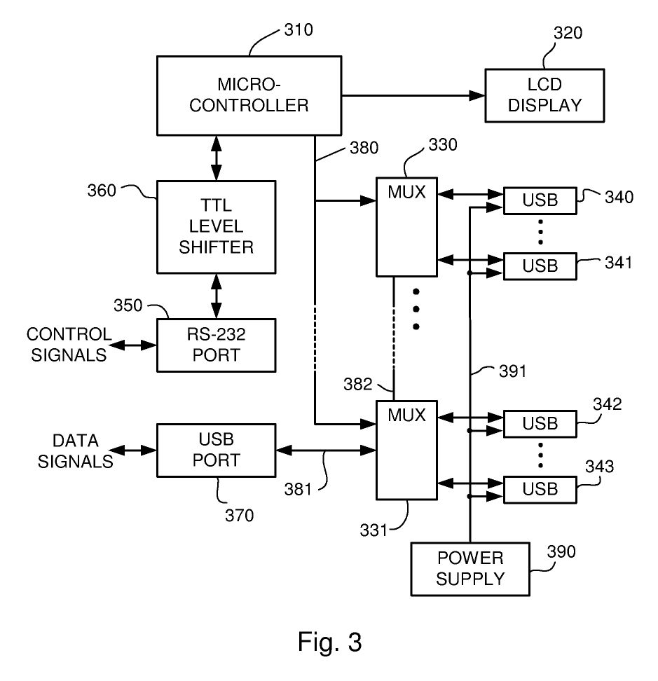

Referring to FIG. 3, a functional block diagram illustrating the structure of a USB switch in accordance with one embodiment is shown. As depicted in this figure, switch 300 includes a data port 370 for interfacing the switch with (i.e., connecting the switch to) a computer, and a set of USB ports (340-343) for connecting the switch to multiple USB peripheral devices. Data is routed between data port 370 and one of the USB ports via a set of multiplexers (330-331.) (The dots below multiplexer 330 are intended to indicate that there may be additional multiplexers between multiplexer 330 and multiplexer 331.) In this embodiment, data is routed serially through one or more of multiplexers 330-331. Thus, for example, if USB port 340 is connected to computer data port 370, the data path from the computer to the peripheral device goes from data port 370, through line 381 to multiplexer 331, then through line 382 (and possibly other multiplexers which are not shown in the figure) to multiplexer 330, and finally through line 383 to USB port 340. (It should be noted that each of lines 381-383 is actually a pair of data lines, but a single line is used in the figure for purposes of clarity.) Data which is communicated from the peripheral device attached to USB port 340 to the computer traverses the same data path, but in the opposite direction.

While the switch of FIG. 3 implements the switching mechanism using a set of multiplexers, it should be noted that this component of the switch can be implemented in various alternative ways. For example, the switching mechanism could be implemented using a series of cascaded relays, switching transistors, solid state switching circuitry, or any other suitable components. By turning on appropriate ones of the relays/switches and turning off others, the computer data interface could be connected to a single one of the peripheral ports. Alternatively, selected relays/switches could be turned off to disconnect all of the peripheral ports from the computer data interface.

The routing of data through multiplexers 330-331 is controlled in this embodiment by microcontroller 310. Microcontroller 310 communicates with the computer to which USB switch 300 is connected via control port 350 and TTL level shifter 360. Control data which is provided by the computer to control port 350 is passed to TTL level shifter 360, which ensures that the voltages of the high and low data signals are adjusted (level shifted) to the appropriate voltages before the signals are passed to microcontroller 310. Based upon the control data received from the computer, microcontroller 310 generates appropriate control signals which it provides to multiplexers 330-331 via control lines 380. Because the microcontroller manages the USB switch based on information received from the computer, the switch can be effectively controlled by software executing on the computer. While control lines 380 are depicted in the figure as a single line for the sake of clarity, it should be noted that there are actually multiple lines, and the control signals provided to each of the multiplexers may be different. In addition to providing control signals to multiplexers 330-331, microcontroller 310 may be configured to provide switch status information, error data, or other information to the computer via TTL level shifter 360 and control port 350.

It should be noted that, while the present embodiment is implemented using what is referred to as a “microcontroller,” any suitable type of data processor can be used. This data processor may be a general-purpose processor, or a processor which is designed specifically to perform the limited number of functions required by the USB switch. Accordingly, references herein to microcontrollers, microprocessors or any other type of data processor should be construed to include any of these different types of processors.

The connections between the computer and the USB switch can be implemented in a variety of ways. Because the present switch is used to connect the computer to different ones of a set of USB devices the computer data interface is preferably a connection between a USB port of the computer and a USB port in the switch. Since the control interface between the computer and the USB switch is novel, it need not follow any particular convention. In one embodiment, the control interface is implemented using RS-232 serial ports on the computer and the USB switch. In another embodiment, only three lines (a receive line, a transmit line, and a ground line) are needed to provide serial communications between the computer and the switch, so the connection is made by providing an RS-232-to-stereo-jack cable which is connected between an RS-232 port on the computer and a stereo jack on the USB switch. Inside the USB switch, the stereo jack is connected through the TTL level shifter to the microcontroller. In other embodiments, USB ports or any other suitable type of connection may be used to provide the control interface between the computer and the switch.

In addition to controlling the routing of data through multiplexers 330-331, microcontroller 310 controls an LCD display 320. In this embodiment, LCD display 320 is a simple, two-line display. Display 320 is used to provide a visual indication of status information to a user. Microcontroller 31 0 may display any desired information on LCD display 320. This information may be switch status information generated by microcontroller 310 itself (e.g., an indication of which USB peripheral port is currently connected to the computer data interface, or an indication that an error has occurred,) or it may be information that the microcontroller receives from the computer (e.g., an indication of the type of program or data that is being communicated to or from the USB peripheral device.)

It should be noted that the display which is provided in the present USB switch would not be useful or desirable in a conventional USB hub because, as noted above, the hub merely makes all of the connected USB devices visible to the computer—there is no distinction between the devices (e.g., one being connected and the others being disconnected,) and the hub does not perform any switching or other active functions which might give rise to error conditions.

It can be seen that USB switch 300 also includes a power supply 390. Power supply 390 is connected by line 391 to each of USB peripheral ports 340-343. (Again, the single-line depicted in the figure represents a pair of physical power lines.) As noted above, while the USB standards allow for USB peripherals to draw a certain amount of current through the USB ports to which their connected, the large number of peripheral devices that are intended to be connected to the present USB switch makes it impractical to allow all of the devices to draw this current from the computer to which the switch is connected. Consequently, power supply 390, which is external to the computer, is incorporated in the design of the present switch in order to meet the power requirements of all of the attached peripheral devices.

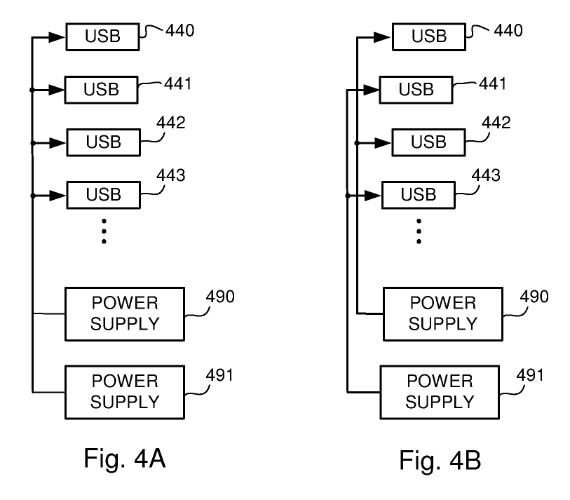

Power supply 390 can be connected to the various USB ports in various ways. Two examples of possible connections are shown in FIGS. 4A and 4B. FIG. 4A illustrates an implementation in which a power supply 490 is connected to each of the USB peripheral ports (440-443.) In this implementation, and a second power supply 491 can be added to the system. Power supply 491 is added in parallel with power supply 490. This implementation has the advantage of being unable to continue to provide power to all of the USB peripheral ports even if one of the power supplies fails, that the failure of one of the power supplies would place additional loading on the other power supply, possibly causing it to fail as well. FIG. 4B illustrates an implementation in which the two power supplies (490, 491) are each connected to different subsets of the USB peripheral ports. Thus, power supply 490 provides power to the subset including peripheral ports 440 and 442, while power supply 491 provides power to the subset including peripheral ports 441 and 443. In this implementation, failure of one of the power supplies will obviously result in a loss of power to the corresponding subset of peripheral ports, but the failure will not increase the loading on the other power supply and consequently will not increase the possibility that the other power supply will fail.

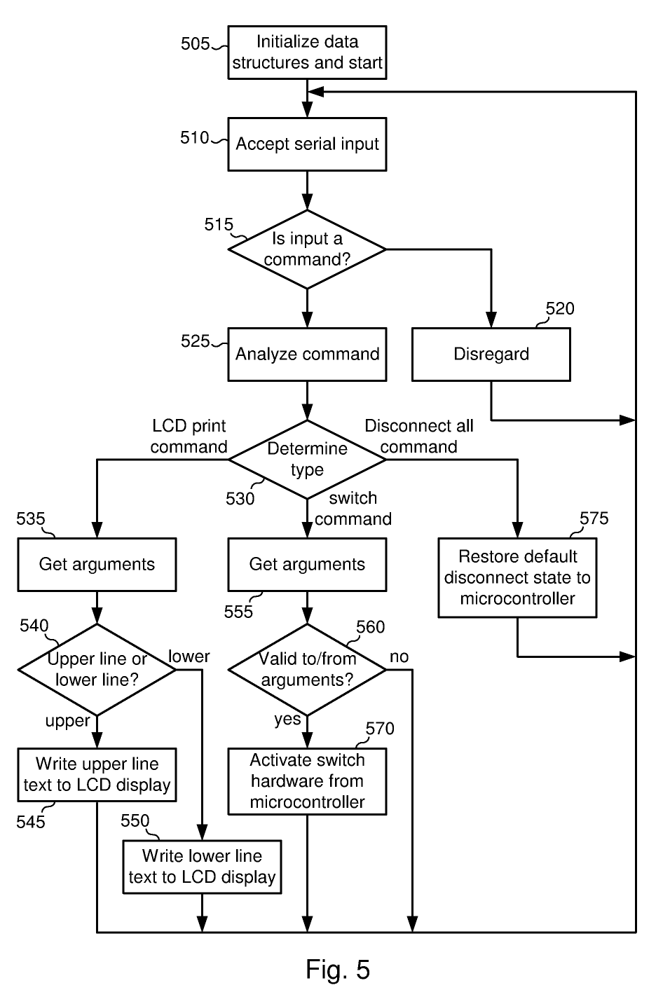

As pointed out above, the operation of the switch is governed in this embodiment by a microcontroller. The operation of the microcontroller is illustrated in FIG. 5. The microcontroller executes firmware (software) which performs the general operations shown in the flow diagram of FIG. 5. These operations begin with the initialization of data structures at the startup of the switch (i.e., when the switch is powered on) that block 505. The microcontroller receives serial input from the computer (510) and parses the input to determine whether or not the serial input is a command (515.) If the serial input does not form a recognizable command, the input is considered noise, and is disregarded (520.) If, on the other hand, the input is recognized as a command, the command is analyzed to determine what type of command it is (525.)

If the command is an LCD print command (530,) the microcontroller determines the arguments associated with the command (535.) The microcontroller and then determines whether the command is associated with the upper line or the lower line of the LCD display (540.) (In this embodiment, the LCD display is a two-line display which is capable of updating either line independently of the other.) If the command is associated with the upper line of the display, the microcontroller writes the appropriate text to the upper line of the display (545,) and if the command is associated with the lower line the display, the microcontroller writes the text to the lower line of the display (550.) After the text is written to the display, the program flow returns to block 510, where the microcontroller accepts further serial input.

Returning again to block 530, if the command is determined to be a switch command, the microcontroller determines the arguments associated with this command (555.) The microcontroller then determines whether the arguments are valid and properly identify the source and destination ports to be connected by the switch (560.) If the arguments are valid, the microcontroller activates the appropriate hardware within the switch to connect to the source and destination ports (570.) If the arguments are not valid, the program flow returns to block 510, where the microcontroller accepts further serial input.

As noted above, the USB switch is configured in this embodiment to either connect a single one of the USB peripheral ports to the computer data interface, or disconnect all of the peripheral ports from the computer data interface. If, at block 530, the microcontroller determines that the command is a “disconnect all” command, the microcontroller sets the hardware of the switching mechanism to disconnect all of the peripheral ports from the computer data interface (575,) which is the default state of the switch at startup. After the microcontroller disconnects all of the peripheral ports, the program flow returns to block 510, where the microcontroller accepts further serial input.

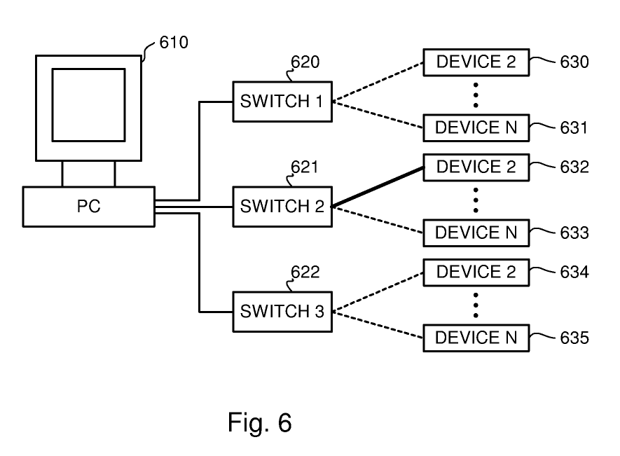

Referring to FIG. 6, a diagram illustrating the use of multiple switches to increase the number of USB peripherals connected to the computer in accordance with one embodiment is shown. In this embodiment, computer 610 has three USB switches (620-622) connected to it rather than a single switch. Each of the USB switches has a corresponding set of peripheral ports (i.e., switch 620 has peripheral ports 630-631, switch 621 has peripheral ports 632-633, and switch 622 has peripheral ports 634-635.) Because it is desired for computer 610 to be connected to only a single one of the USB peripheral devices (as opposed to one device for each switch,) is necessary for two of the three USB switches to disconnect all of their peripheral ports, while the third USB switch connects a single one of its peripheral ports to the computer. As illustrated in the figure, switch 621 has connected peripheral port 632 to the computer data interface (as indicated by the solid line,) while all other peripheral ports are disconnected (as indicated by the dotted lines.) The number of USB peripherals that can be connected to the computer can therefore be easily scaled. For example, if it is desired to be able to selectively connect to 200 USB peripheral devices, the computer can be connected to four USB switches, each of which has 52 peripheral ports (for a total capacity of 208 ports.)

It should be understood that, while the foregoing embodiments are designed specifically to provide connections between a computer and selected ones of a set of USB devices, other embodiments may connect other types of devices. For example, the switch may be configured to connect audio or video devices to the computer. Conversely, the switch may also be configured to connect the devices to equipment other than a computer.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, including wires, metallic traces, vias, and the like.

Those of skill will further appreciate that the various illustrative logical blocks, modules, circuits, and algorithm steps described in connection with the embodiments disclosed herein may be implemented as electronic hardware, computer software (including firmware,) or combinations of both. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein.

The steps of a method or algorithm described in connection with the embodiments disclosed herein may be embodied directly in hardware, in software or firmware (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor. The processor and the storage medium may reside, for example, in an ASIC.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A system comprising:
a data port;
a plurality of peripheral device ports; and
a switch configured to selectively connect the data port to no more than one of the peripheral device ports.

2. The system of claim 1,
further comprising
a processor coupled to the switch and configured to control the switch,
a display coupled to the processor and configured to display information provided by the processor,
a control port configured to connect the system to a computer, and
one or more power supplies connected to the peripheral ports and
configured to provide power to the peripheral ports;
wherein
the data port comprises a USB port configured to connect the system to the computer, and
the peripheral device ports comprise USB ports configured to connect the system to corresponding USB peripheral devices.

3. The system of claim 1, further comprising a control port which is separate from the data port.

4. The system of claim 3, wherein the control port comprises an RS-232 port configured to connect the system to a computer.

5. The system of claim 1, further comprising a processor which is coupled to the switch and configured to control the switch to selectively connect the data port to no more than one of the USB ports.

6. The system of claim 5, further comprising a display coupled to the processor.

7. The system of claim 1, one or more power supplies connected to the peripheral ports and configured to provide power to the peripheral ports.

8. The system of claim 1, wherein the switch comprises one or more multiplexers.

9. The system of claim 1, wherein the switch comprises one or more relays.

10. The system of claim 1, wherein the switch is configured to alternately connect the data port to a single one of the peripheral device ports or none of the peripheral device ports.

11. The system of claim 1, wherein the data port comprises a USB port configured to connect the system to a computer.

12. The system of claim 1, wherein the peripheral device ports comprise USB ports configured to connect the system to corresponding USB peripheral devices.

13. A method comprising:
providing a data port;
providing a plurality of peripheral device ports; and
selectively connecting the data port to no more than one of the peripheral device ports.

14. The method of claim 13, wherein the data port and the peripheral device ports comprise USB ports.

15. The method of claim 14, further comprising connecting the data port to a computer and connecting each of the USB peripheral device ports to corresponding USB peripheral devices.

16. The method of claim 15, further comprising providing power to each of the USB peripheral device ports from a power source external to the computer.

17. The method of claim 15, executing software on the computer, wherein the software is configured to control the connection of the data port to the peripheral device ports.

18. The method of claim 13, further comprising alternately connecting the data port to a single one of the peripheral device ports or none of the peripheral device ports.

19. The method of claim 13, further comprising displaying to a user status information associated with the connection of the data port to the peripheral device ports.
